(19) United States
(12) Patent Application Publication
(10) Pub. No.: US 2022/0158527 A1
(43) Pub. Date: May 19, 2022

(54) ELECTRICAL GENERATION

(71) Applicant: UNIVERSITY OF EXETER, Exeter (GB)

(72) Inventors: Meiling ZHU, Exeter (GB); Yang KUANG, Exeter (GB)

(21) Appl. No.: 17/600,838

(22) PCT Filed: Apr. 1, 2020
(86) PCT No.: PCT/EP2020/059221

§ 371 Date: Oct. 1, 2021

(30) Foreign Application Priority Data
Apr. 2, 2019 (GB) 1904599.6

(51) Int. Cl. H02K 7/18

(52) U.S. Cl. CPC H02K 7/1892; H02K 7/1853

(57) ABSTRACT

An electrical generation apparatus is described comprising a magnetic mass (18) magnetically attracted to a guide member (14) such that the mass (18) is moveable, in use, along a path defined by the shape of the outer periphery of the guide member (14), the mass (18) being moveable past a coil (20), and at least one repulsion magnet (16a, 16b) of the same polarity as the mass (18) and positioned to repel the mass (18) such that the mass (18) undertakes a pendulum-like reciprocating motion, repeatedly passing the coil.

This invention relates to an apparatus for use in the generation of electricity, and in particular to an apparatus whereby electricity can be generated from the movement of a moveable component, for example being moved at low frequencies and potentially through small displacements. By way of example, the invention may be suitable for use in body worn devices, harvesting energy from small body movements. It will be appreciated, however, that the invention is not restricted in this regard.

A number of forms of electrical generator are known. One device suitable for use in the generation of electricity from the movement of a moveable component is described in “Rolling mass energy harvester for very low frequency of input vibrations”, Jan Smilek, Zdenek Hadas, Jan Vetiska, Steve Beeby, Mechanical Systems and Signal Processing, 6 Jun. 2018, and comprises a movable mass that is guided for rolling movement along a wall defining a circular cavity formed in a guide member. A fixed coil is located at the centre of the cavity, positioned such that rolling movement of the mass around the cavity results in all parts of the periphery of the mass moving past the coil. Magnets are located at the periphery of the mass, and the movement of the magnets past the coil induces an electrical current in the coil. In normal use, relative movement between the mass and a component to which the guide member is attached or forms part results in the mass moving relative to the coil, and hence in the generation of a current. However, one disadvantage of the arrangement described is that movement of the guide member in certain directions relative to the mass may tend to cause the mass to lift away from the guide member with the result that the movement of the mass is no longer properly guided. Similarly, sliding movement of the mass as opposed to rolling movement thereof, interrupts the passage of the magnets past the coil. As a consequence, electrical generation may temporarily cease or may be of reduced efficiency until such time as the mass once again moves into contact with the guide member so that it is properly guided for rolling movement.

In addition, frictional losses between the mass and the guide member may be relatively high, leading to significant damping of the movement of the magnets relative to the coil, and hence in relatively poor efficiency.

It is an object of the invention to provide an electrical generation apparatus in which at least some of the disadvantages associated with known arrangements are overcome or are of reduced effect.

According to the present invention there is provided an electrical generation apparatus comprising a magnetic mass magnetically attracted to a guide member such that the mass is moveable, in use, along a path defined by the shape of the outer periphery of the guide member, the mass being moveable past a coil, and at least one repulsion magnet of the same polarity as the mass and positioned to repel the mass such that the mass undertakes a pendulum-like motion, repeatedly passing the coil.

Preferably, two repulsion magnets are provided.

The presence of the repulsion magnets results in the application of non-linear forces on the mass, in use. As a result, secondary resonance may be experienced, and an increased power bandwidth achieved.

It will be appreciated that as the mass is magnetically attracted to the guide member, the disadvantage set out hereinbefore of certain movements resulting in the mass no longer being guided for movement past the coil is overcome.

The presence of the repulsion magnet is advantageous in that an initial input movement may result in the mass repeatedly moving past the coil.

The mass is conveniently of circular shape and its movement relative to the guide member is preferably a rolling movement. Such an arrangement is advantageous in that frictional losses are kept to a relatively low level.

Preferably, the mass is guided for movement between a pair of coils.

The guide member preferably comprises a permanent magnet. It conveniently has an outer periphery of circular shape. It will be appreciated, however, that guide members of other shapes could be used, preferably with a smoothly curved outer periphery so that the path along which the mass is guided is of smoothly curved form.

The invention will further be described, by way of example with reference to the accompanying drawings, in which:

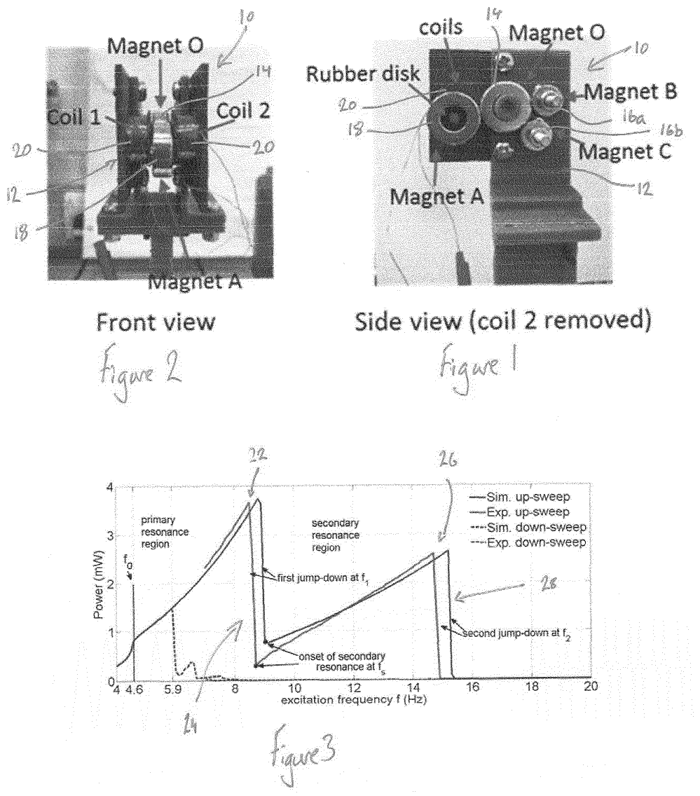

FIG. 1 is a representation of an electrical generation apparatus in accordance with an embodiment of the invention;

FIG. 2 is another view of the apparatus of FIG. 1;

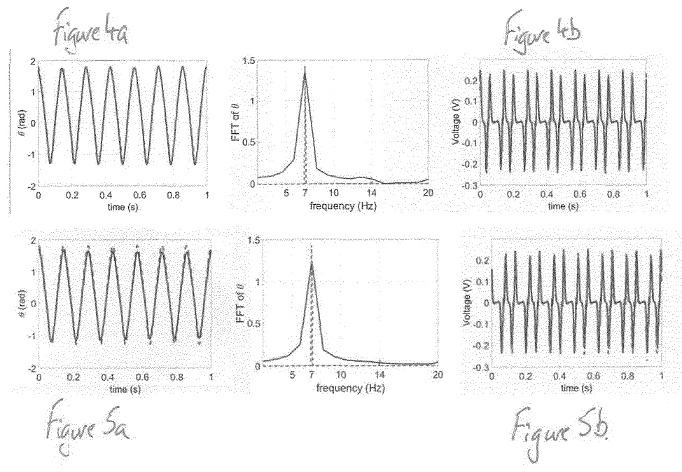

FIG. 3 is a graph illustrating variations in output at different input movement frequencies; and

FIGS. 4a, 4b, 5a and 5b are graphs illustrating the displacement of the mass and associated electrical outputs at different input movement frequencies.

Referring to the accompanying drawings, an electrical generation apparatus 10 is illustrated. The apparatus 10 comprising a support 12 in the form of a pair of support plates arranged parallel to one another and between which is located a guide member 14 of cylindrical form and of a magnetic material. In addition, between the support plates, and supported by the support plates, are located a pair of repulsion magnets 16a, 16b.

A magnetic material mass 18 of cylindrical form is located between the support plates but, unlike the guide member 14 and the repulsion magnets 16a, 16b, the mass 18 is free to move relative to the support 12. The magnetic polarity of the mass 18 is such that it is magnetically attracted to the guide member 14, orientated such that its axis is substantially parallel to the axis of the guide member 14. The mass 18 is thus free to rotate around the periphery of the guide member 14.

The polarity of the repulsion magnets 16a, 16b is chosen such that the repulsion magnets 16a, 16b magnetically repel the mass 18. Accordingly, as the mass 18 rotates and moves around the periphery of the guide member 14, a point will be reached at which the repulsion between the mass 18 and a first one of the repulsion magnets 16a causes a noticeable deceleration of the mass 18, subsequently causing the mass 18 to reverse its direction of movement and to accelerate away from that one of the repulsion magnets 16a, following the periphery of the guide member 14 towards the second one of the repulsion magnets 16b. The interaction between the mass 18 and the second one of the repulsion magnets 16b similarly causes slowing and reversal of the direction of movement of the mass 18. It will be appreciated, therefore, that the mass 18 will undergo a pendulum like reciprocating motion, following a path defined by the exterior of the guide member 14.

The support plates carry electrical coils 20 positioned such that as the mass 18 undergoes its pendulum like reciprocating motion, the mass 18 moves between and past the electrical coils 20, inducing an electrical current therein and so resulting in the generation of electricity.

It will be appreciated that as the mass 18 is magnetically attracted to the guide member 14, no additional features are required to retain the mass 18 in contact with the guide member 14, and so frictional losses are reduced. The mass 18 is thus well supported and guided for movement, regardless as to the direction in which an input movement is applied to the apparatus 10. At least some of the losses associated with certain known electrical generation devices are thus overcome or are of reduced effect, and energy can be harvested from a wide variety of directions of input movements.

Additionally, the presence of the repulsion magnets 16a, 16b increases the level of non-linearity in the forces experienced by the mass 18, and the motion thereof, and this has the benefit that the apparatus 10 is able to effectively harvest energy over an increased range of frequencies of input movement. As shown in FIG. 3, the apparatus 10 exhibits hysteretic responses when excitation frequency is greater than 5.9 Hz, where two stable responses co-exist. In the hysteretic region, the power of the up-sweep is always higher than the down-sweep, suggesting hardening nonlinearity of the apparatus 10.

In FIG. 3, as the excitation frequency increases, the power output experiences a sharp jump-up around the linear resonance frequency of 4.6 Hz, after which it increases steadily until it reaches a first peak 22 at a frequency of around 8.5 Hz. This is immediately followed by a first steep jump-down 24. The frequency region from low frequency until this point is the primary resonance region, where the frequency of the displacement of the mass 18 is equal to the excitation frequency. FIGS. 4a and 4b illustrate the mass displacement and corresponding output for a displacement frequency of 7 Hz, showing that with an input displacement frequency of 7 Hz, the main frequency component of the output voltage is at 14 Hz, as each cycle of displacement introduces two cycles of magnetic flux variations.

After the first jump-down 24, the power produced by the apparatus 10 increases again with frequency until a second peak 26 and jump-down 28 are observed at around 15 Hz. The frequency range between the first jump-down 24 and the second jump-down 28 is the secondary resonance region. In this region, the displacement frequency is primarily at half of the excitation frequency, suggesting that the secondary resonance is a half order subharmonic resonance originating from the quadratic nonlinearity. A typical example in shown in FIGS. 5a and 5b, where the apparatus 10 is excited at 14 Hz, showing that the displacement and electrical output are substantially the same as at a 7 Hz input displacement frequency.

The secondary resonances of typical non-linear energy harvesters produce much smaller responses than the primary resonance. In contrast, the secondary resonance of the apparatus 10 at higher frequencies always produces almost identical outputs to the primary resonance at lower frequencies across the whole secondary resonance region, as can be seen by comparing FIG. 4b with FIG. 5b. The secondary resonance always takes the same form as the primary counterpart and looks like a recurrence of the primary resonance at doubled excitation frequencies. This unique phenomenon is advantageous for energy harvesting because the secondary resonance can produce the same power level as the primary resonance but with a larger bandwidth.

It will be appreciated that the arrangement of the present invention is advantageous in that, as discussed hereinbefore, it can operate effectively over a wide range of operating frequencies, and it can operate efficiently with relatively low frictional losses. In addition, it can operate using input movements in a wide range of directions.

Whilst a specific embodiment of the invention is described herein, it will be appreciated that a wide range of modifications and alterations may be made thereto without departing from the scope of the invention as defined by the appended claims. By way of example, whilst in the arrangement described hereinbefore the mass 18 is guided for movement by a guide member 14 of cylindrical form defining a circular guide path, it will be appreciated that the path of movement along which the mass 18 is guided may be of other shapes, for example of elliptical form or the like. However, this represents just one area of the design that may be modified, and the invention can encompass a number of other changes.

1. An electrical generation apparatus comprising a magnetic mass magnetically attracted to a guide member such that the mass is moveable, in use, along a path defined by the shape of the outer periphery of the guide member, the mass being moveable past a coil, and at least one repulsion magnet of the same polarity as the mass and positioned to repel the mass such that the mass undertakes a pendulum-like reciprocating motion, repeatedly passing the coil.

2. An apparatus according to claim 1, wherein two repulsion magnets are provided.

3. An apparatus according to claim 1, wherein the presence of the repulsion magnets results in the application of non-linear forces on the mass, in use.

4. An apparatus according to claim 1, wherein the mass is of circular shape and its movement relative to the guide member is a rolling movement.

5. An apparatus according to claim 1, wherein the mass is guided for movement between a pair of coils.

6. An apparatus according to claim 1, wherein the guide member comprises a permanent magnet.

7. An apparatus according to claim 1, wherein the guide member has an outer periphery of circular shape.

8. An apparatus according to claim 1, wherein the guide member has a smoothly curved outer periphery so that the path along which the mass is guided is of smoothly curved form.
